(19) United States
(12) Patent Application Publication
(10) Pub. No.: US 2025/0350444 A1
(43) Pub. Date: Nov. 13, 2025

(54) PLATFORM AND METHOD FOR ENCRYPTED INTERACTION

(71) Applicant: HOOXPAY LTD, 2 Kikar HaTsamarot (IL)

(72) Inventors: Oz AZARIA, Petach Tikva (IL); Guy FREEDMAN, Caesaria (IL)

(21) Appl. No.: 18/995,764

(22) PCT Filed: Sep. 20, 2023
(86) PCT No.: PCT/IL2023/051020

§ 371 Date: Jan. 16, 2025

Related U.S. Application Data
(60) Provisional application No. 63/408,534, filed on Sep. 21, 2022.

(51) Int. Cl. H04L 9/08; H04L 9/32

(52) U.S. Cl. CPC H04L 9/0825; H04L 9/0861; H04L 9/0891; H04L 9/3236; H04L 2209/42

(57) ABSTRACT

Disclosed herein is a platform for secured communication between two or more parties, comprising: a first server comprising a first processor executing a code configured to: receive a personally identifiable information (PII) of a user of a first party; generate a first ciphertext from the PII; transmit the first ciphertext, such that transmitting the PII is avoided; a second server comprising a second processor executing a code configured to: receive PII of a user of a second party; generate a second ciphertext from the PII; transmit the second anonymized ciphertext, such that transmitting the PII is avoided; and a buffer server comprising a third processor executing a code configured to: receive and store the first and the second ciphertexts; search for a match between the first and the second ciphertexts, thereby allowing performing a transaction/interaction between the first and the second party without transmitting the PII of users therebetween.

### TECHNICAL FIELD

The present disclosure relates generally to platforms and methods for secured communication between two or more parties.

### BACKGROUND

Communication systems and methods, and in particular, cryptographic methodologies are the cornerstone of data security, employed to protect sensitive and private information during transmission thereof. These methods predominantly utilize encryption protocols and methodologies to uphold confidentiality and integrity. However, one of the central issues revolving around cryptographic communication methodologies is the perpetual evolution of cyber threats, dictionary attacks, and the like. Furthermore, errors in key management or exploitation of these processes may compromise the security of cryptographic communications.

In the current era of ubiquitous connectivity and increasing requirements for privacy and security, there is a need in the art for constructing secured communications solutions for various network setups.

### SUMMARY

Aspects of the disclosure, according to some embodiments thereof, relate to a platform and a method for secured communication between two or more parties. More specifically, but not exclusively, aspects of the disclosure, according to some embodiments thereof, relate to secured communication between a first party, a second party and a user or a consumer. In some embodiments, aspects of the disclosure relate to secured communication between two or more parties.

Thus, according to an aspect of some embodiments, there is provided a cryptographic communication platform for performing a transaction/interaction between two or more parties, the platform including: a first server including a first processor executing a code configured to: receive, a personally identifiable information (PII) of a user of a first party; generate a first anonymized ciphertext from the PII of the user of the first party; transmit the first anonymized ciphertext server, such that transmitting the PII of the user of the first party is avoided; a second server including a second processor executing a code configured to: receive, a PII of a user of a second party; generate a second anonymized ciphertext from the PII of the user of the second party; and transmit the second anonymized ciphertext to, such that transmitting the PII the user of the second party is avoided; and a buffer server comprising a third processor executing a code configured to: receive and store the first anonymized ciphertext from the first server and the second anonymized ciphertext from the second server; search for a match between the first and the second anonymized ciphertexts, thereby allowing performing a transaction/interaction between the first and the second party without transmitting the PII of users therebetween.

According to some embodiments, the platform may be compliant with privacy laws. According to some embodiments, the platform advantageously allows providing a user offers/services from a first party without revealing it in real time to the first party.

According to some embodiments, the first anonymized cipher text may be configured to be equal to the second anonymized cipher text to allow the transaction/interaction, and wherein the search for the match comprises searching for equality between the first ciphertext and the second ciphertext to allow performing the transaction/interaction.

According to some embodiments, the first and the second servers may include common features.

According to some embodiments, each of the processors of the first server and the second server is configured to generate the first and the second anonymized ciphertext, respectively, by using a cryptographic hash function (CHF).

According to some embodiments, the platform may further include a key management system (KMS), the KMS is configured to: generate a first cryptographic key for each of the PII of users; and transmit the first cryptographic key to the first and the second servers.

According to some embodiments, the KMS may be external to the buffer server, the first server and the second server.

According to some embodiments, each of the processors of the first and the second servers may be configured to execute a code configured to: receive PII of a user and the first cryptographic key; receive or determine rules for weaving the first cryptographic key into the PII of the user; weave the first cryptographic key into the PII of each user according to the rules for weaving, thereby generating a first string, the first string comprising characters of the PII of the user and characters of the first cryptographic key; and output the first string; wherein the first cryptographic key used in the first server is identical to the first cryptographic key used in the second server; and wherein the string is configured to be fed into the CHF for generating each of the first anonymized ciphertext and the second anonymized ciphertext by each of the first and the second server, respectively.

According to some embodiments, the first and the second processors may execute a code further configured to: receive a new first cryptographic key generated by the KMS; store a previously used first cryptographic key and the rules for weaving thereof in a key history stack of each of the first server and the second server; and replace the previously used first cryptographic key with the new first cryptographic key, thereby enabling backwards compatibility.

According to some embodiments, the third processor of the buffer server may be configured to execute a code configured to: receive the first anonymized ciphertext from the first server or the second anonymized ciphertext from the second server; transmit the first anonymized ciphertext or the second anonymized ciphertext to the KMS, wherein the KMS is configured to generate a second cryptographic key, the second cryptographic key is stored in the KMS without being transmitted therefrom, the KMS is configured to weave the second cryptographic key into the first anonymized ciphertext or the second anonymized ciphertext, thereby generating a second string, the second string including characters of the first or the second anonymized ciphertexts and characters of the second cryptographic key, the KMS is configured to feed the second string into the CHF, thereby generating an encrypted form of the first or the second anonymized ciphertext; and receive and store the encrypted form of the first or the second anonymized ciphertext in a buffer database, thereby updating the database, enabling backward compatibility, and minimizing/preventing dictionary attacks.

According to some embodiments, the third processor of the buffer server may be configured to execute a first set of rules, the first set of rules is determined by the first and/or the second party, and wherein attempts to execute the first set of rules for the user of the second party are unknown to the first party.

According to some embodiments, the second processor of the second server may be configured to execute a first set of rules, the first set of rules is determined by the first and/or the second party, and wherein attempts to execute the first set of rules for the user of the second party are unknown to the first party.

According to some embodiments, the third processor of the buffer server or the second processor of the second server may be configured to execute a second set of rules, the second set of rules is determined by the first and/or the second party in case the match is not found.

According to some embodiments, the processors of the first and second servers may execute a code further configured to: attach dynamic metadata to each of the first and the second anonymized ciphertext, thereby enabling user segmentation.

According to some embodiments, there is provided a cryptographic communication platform for performing a transaction/interaction between two or more parties, the platform including: a first server including a first processor executing a code configured to: receive a PII of a user of a first party, generate, by applying an asymmetric encryption method, a first anonymized ciphertext from the PII of the user of the first party, transmit the first anonymized ciphertext server, such that transmitting the PII of the user of the first party is avoided; a second server including a second processor executing a code configured to: receive, a PII of a user of a second party, generate, by applying the asymmetric encryption method, a second anonymized ciphertext from the PII of the user of the second party, and transmit the second anonymized ciphertext to, such that transmitting the PII the user of the second party is avoided; and a buffer server including a third processor executing a code configured to: receive and store the first anonymized ciphertext from the first server and the second anonymized ciphertext from the second server, search for a match between the first and the second anonymized ciphertexts, thereby allowing performing a transaction/interaction between the first and the second party without transmitting the PII of users therebetween.

According to some embodiments, the platform may further include an KMS, the KMS is configured to: generate a first pair of asymmetric keys for encrypting the PII of users of the first party; and generate a second pair of asymmetric keys for encrypting the PII of users of the second party.

According to some embodiments, the buffer server may be configured to resolve a dispute between the first and the second party by restoring the transaction/interaction therebetween.

According to some embodiments, there is provided a computer implemented method for performing secured interaction between two or more parties, the method including: receiving a PII of a user of a first party; generating a first anonymized ciphertext from the PII of user of a first party by a first server; transmitting the first ciphertext to a buffer server, such that transmitting the PII of users of the first party is avoided; receiving a PII of a user of a second party; generating a second anonymized ciphertext from a PII of user of a second party by a second server; transmitting the second anonymized ciphertext to the buffer server, such that transmitting the PII of users of the second party is avoided; receiving, by the buffer server, the first anonymized ciphertext from the first server and the second anonymized ciphertext from the second server; searching for a match between the first and the second anonymized ciphertexts, thereby allowing performing a transaction/interaction between the first and the second party without transmitting the PII of users therebetween, and wherein performing the transaction/interaction includes executing a set of rules defined by the first party and/or the second party without revealing attempts of the execution of the set of rules to the first or the second party.

According to some embodiments, receiving a PII of a user may include receiving a database of users of the first/second party.

According to some embodiments, generating each of the first and the second anonymized ciphertext may include using a CHF.

According to some embodiments, wherein generating each of the first and the second anonymized ciphertext by each of the first and the second server, respectively, may include: generating a first cryptographic key; determining rules for weaving the first cryptographic key into the PII of each user; weaving the first cryptographic key into the PII of each user, thereby generating a first string, wherein the first cryptographic key used in the second server is identical to the first cryptographic key used in the first server; feeding each of the first string into the CHF for generating each of the first anonymized ciphertext and the second anonymized ciphertext by each of the first and the second server, respectively.

According to some embodiments, the first cryptographic key may be generated by an KMS.

According to some embodiments, the method may further include using a key history stack of the first and the second servers to generate each of the first and the second anonymized ciphertexts, respectively, wherein the key history stack includes one or more previously used first cryptographic keys and corresponding rules of weaving of each of the one or more previously used first cryptographic keys.

According to some embodiments, the method may further include replacing the first cryptographic key, replacing the first cryptographic key including: generating a new first cryptographic key; transmitting the new first cryptographic key to each of the first and the second servers; storing a previously used first cryptographic key in the key history stack of each of the first and the second servers, to enable backwards compatibility; and replacing the previously used first cryptographic key with the new cryptographic key.

According to some embodiments, the method may further include forming and updating a database of the buffer server, including: transmitting the first anonymized ciphertext or the second anonymized ciphertext received from the first and the second servers, respectively, to the KMS; generating, by the KMS, a second cryptographic key, the second cryptographic key is stored in the KMS without being transmitted there from; weaving the second cryptographic key into the first anonymized ciphertext or the second anonymized ciphertext, thereby generating a second string, the second string comprising characters of the first or the second anonymized ciphertexts and characters of the second cryptographic key; feeding the second string into the CHF for encrypting the second string, thereby generating an encrypted form of the first or the second anonymized ciphertext; transmitting the encrypted form of the first or the second anonymized ciphertext to the buffer server; and storing the encrypted form of the first or the second anonymized ciphertext in the buffer database, thereby updating the database, enabling backward compatibility, and minimizing/preventing dictionary attacks.

According to some embodiments, there is provided a buffer server for performing transaction/interaction between two or more parties, such that attempts to execute rules defined by a first party of the two or more parties are unknown to a second party, the buffer server including one or more processors configured to: receive and store a first anonymized ciphertext from a first server and a second anonymized ciphertext from a second server; search for a match between the first and the second anonymized ciphertexts, thereby allowing performing a transaction/interaction between the first and the second party without sharing/transmitting the PII of users therebetween and executing a set of rules received from the first and/or the second party, such that attempts to execute the rules are not revealed to the first or to the second party; and update an encryption protocol of each of the first and the second parties.

According to some embodiments, there is provided a server for performing transaction/interaction between two or more parties, such that attempts to execute rules defined by a first party of the two or more parties are unknown to a second party, the server including one or more processors configured to: receive a PII of a user; encrypt the PII by according to a history stack of the server, the history stack comprises previously used first cryptographic keys and weaving rules thereof; receive a new first cryptographic key; receive or determine rules for weaving the new cryptographic key into the PII of the user; weave the new first cryptographic key into the encrypted PII, thereby generating a string; feed the string into a CHF, thereby generating a ciphertext of the PII of the user; and transmit the ciphertext to a buffer server.

According to some embodiments, there is provided a cryptographic communication platform for performing a transaction/interaction between two or more parties, the platform including: a first server including a first processor executing a code configured to: receive a PII of a user of a first party, generate a first anonymized ciphertext from the PII of the user of the first party, transmit the first anonymized ciphertext server, such that transmitting the PII of the user of the first party is avoided; a second server comprising a second processor executing a code configured to: receive PII of a user of a second party; generate a second anonymized ciphertext from the PII of the user of the second party, and transmit the second anonymized ciphertext to, such that transmitting the PII the user of the second party is avoided; and a buffer server including a third processor executing a code configured to: receive and store the first anonymized ciphertext from the first server and the second anonymized ciphertext from the second server; search for a match between the first and the second anonymized ciphertexts, thereby allowing performing a transaction/interaction between the first and the second party without transmitting the PII of users therebetween; wherein the platform includes a first and a second user interface

(UI) for interacting with the first and the second server, respectively; and wherein the platform includes a third user interface for communicating with the buffer server, and wherein the buffer server is configured to generate performance data of the platform.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the methods herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, flash memories, solid state drives (SSDs), or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein. Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1A schematically depicts a communication flow of a platform, according to some embodiments;

FIG. 1B schematically depicts a block diagram of the platform of FIG. 1A, according to some embodiments;

FIG. 2 schematically depicts a flowchart of a method for performing secured interaction/communication between two or more parties;

FIG. 3 schematically depicts a flowchart of an example of the method of FIG. 2 for performing secured interaction/communication between two or more parties;

FIG. 4 schematically depicts a tokenization flow of a platform, according to some embodiments; and

FIG. 5 schematically depicts an example of a platform utilized in e-commerce, according to some embodiments.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

As used herein, according to some embodiments, the term “party” may refer to any entity, such as but not limited to, commercial entities, such as a business, association of businesses, any type of a public or private organization, health care or any other service providers, advertisers, publishers, merchants, and any other type of parties. According to some embodiments, the term “party” may refer to any type of a commercial oriented entity. According to some embodiments, the commercial orientated entity may include corporations, companies, and the like. As a non-limiting example, the commercial oriented entity may include banks, flight companies, brands, loyalty clubs, or any other type of consumer hubs. Each possibility is a separate embodiment. According to some embodiments, the term “party” may refer to any entity transmitting advertisements. According to some embodiments, the term “party” may refer to a client, a user, a customer, a potential customer, and/or a group thereof. It may be understood that the term “party”, in some embodiments, may refer to a plurality of parties. According to some embodiments, the term “party” may refer to a combination of persons, users, organizations, and/or any other entities which may be associated or not associated with one another. It may be understood that the term “party” may not be limited to being associated with any particular type or types of entities.

As used herein, according to some embodiments, the terms “party” and “side” may be interchangeable.

According to some embodiments, there is provided herein a cryptographic communication platform for performing a transaction/interaction between two or more parties.

Advantageously, in some embodiments, the disclosed platform is configured to allow communicating and/or performing transactions/interactions between a first and a second party, wherein communicating and/or performing transactions/interactions includes executing a set of rules defined by the first party, such that attempts of the execution of the rules are unknown to the first party.

Advantageously, in some embodiments, a personally identifiable information (PII) of a user may not be transmitted from the server or device in which they were typed into by the user, thereby protecting privacy of the user. Advantageously, in some embodiments, the PII may not be shared between servers, platforms, or any other type of network communication devices.

Advantageously, in some embodiments, the disclosed platform is configured to minimize and/or substantially avoid data loss (e.g., during a key swap operation).

Advantageously, in some embodiments, the disclosed platform is designed to improve resistance to dictionary attacks.

According to some embodiments, there is provided herein a cryptographic communication platform for performing a transaction/interaction between two or more parties, the platform including: a first server including a first processor executing a code configured to: receive a PII of a user of a first party; generate a first anonymized ciphertext from the PII of the user of the first party; transmit the first anonymized ciphertext to a buffer server, such that transmitting the PII of the user of the first party is avoided; a second server including a second processor executing a code configured to: receive PII of a user of a second party; generate a second anonymized ciphertext from the PII of the user of the second party; and transmit the second anonymized ciphertext to the buffer server, such that transmitting the PII the user of the second party is avoided; and the buffer server including a third processor executing a code configured to: receive and store the first anonymized ciphertext from the first server and the second anonymized ciphertext from the second server; search for a match between the first and the second anonymized ciphertexts, thereby allowing performing a transaction/interaction between the first and the second party without transmitting the PII of users therebetween.

Advantageously, searching for the match includes comparing encrypted data (i.e., the first and the second anonymized data), without knowing the PII of the user.

According to some embodiments, there is provided herein a computer implemented method for performing secured interaction between two or more parties.

Advantageously, according to some embodiments, the method may enable backward compatibility.

Advantageously, according to some embodiments, the disclosed method is designed to increase resistance to attacks, thereby improving security thereof. Advantageously, according to some embodiments, the disclosed method is designed to increase resistance to dictionary attacks, thereby improving security thereof.

Advantageously, according to some embodiments, the method may reduce data loss during operation thereof.

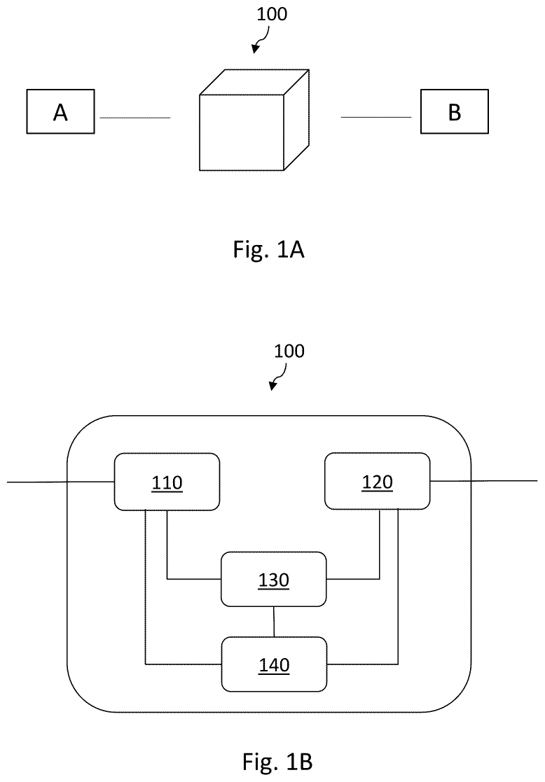

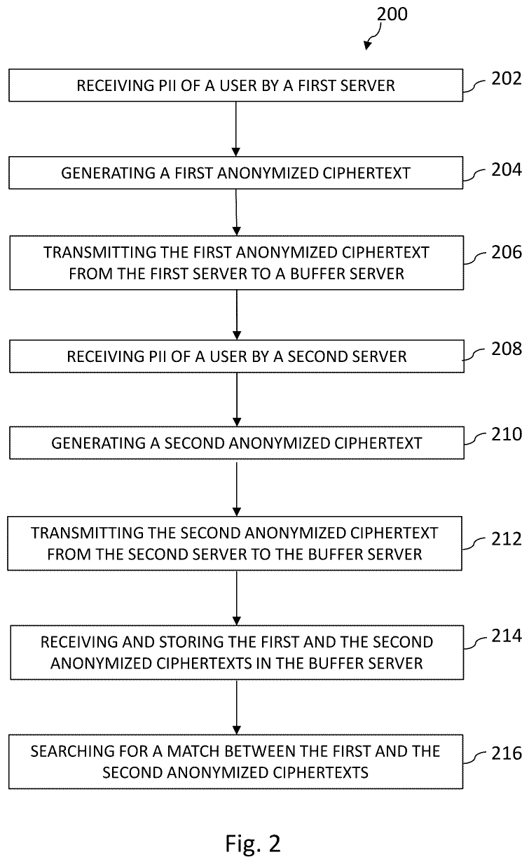

Reference is now made to FIG. 1A, which schematically depicts a communication flow from a first party (marked as “A”) to a second party (marked as “B”) and vice versa by utilizing a cryptographic communication platform 100, according to some embodiments.

According to some embodiments, the first party may include any type of organization, business, and the like. According to some embodiments, the first party may include a commercially oriented entity. According to some embodiments, the commercial oriented entity may include, among others, any type of business organizations and/or governmental organizations. According to some embodiments, the commercial oriented entity may include for-profit and/or non-profit organizations. According to some embodiments, the commercial orientated entity may include corporations, companies, and the like. As a non-limiting example, the commercial oriented entity may include banks, airlines, brands, loyalty clubs, insurance companies, card networks or any other type of consumer hubs. Each possibility is a separate embodiment.

According to some embodiments, the first party may include a plurality of parties.

According to some embodiments, the first party may have a first party database. According to some embodiments, the first party database may include personally identifiable information (PII) of users thereof.

According to some embodiments, the first party database may include any type of consumer or user-related data. According to some embodiments, the first party database may include, among others, a full name, ID/Passport number, phone number, email address, home and/or work address, savings/checking account, date of birth, sex, gender, and the like, or any combination thereof. According to some embodiments, the first party database may include answers to security questions. According to some embodiments, the first party database may include medical records or any other health-related information. Each possibility is a separate embodiment.

According to some embodiments, the second party may include any commercially oriented entity. According to some embodiments, the second party may include entity transmitting advertisements. According to some embodiments, the second party may include a client, a potential client, a user, a customer, a potential customer, and/or a group thereof. Each possibility is a separate embodiment.

According to some embodiments, the second party may include a plurality of parties. According to some embodiments, the second party may be substantially similar to a first party. As a non-limiting example, each of the first and the second parties may include business organizations.

According to some embodiments, the first and the second party may at least partially share mutual users/consumers. Alternatively, in some embodiments, the first and the second party may be devoid of mutual users/consumers.

According to some embodiments, the second party may have a second party database. According to some embodiments, the second party database may include PII of users thereof. According to some embodiments, the second party database may include, among others, a full name, ID/Passport number, phone number, email address, home and/or work address, savings/checking account, card credentials, date of birth, sex, gender, and the like, or any combination thereof. According to some embodiments, the second party database may include answers to security questions. According to some embodiments, the second party database may include medical records or any other health-related and/or lifestyle-related information. Each possibility is a separate embodiment. Alternatively, in some embodiments, the second party may be devoid of the second party database.

According to some embodiments, platform 100 may include a first server, a second server and a buffer server. According to some embodiments, platform 100 may include a plurality of first and/or second servers, and a buffer server (embodiment not shown).

According to some embodiments, the first server of platform 100 may be in communication with and/or installed at the first party. According to some embodiments, the second server of platform 100 may be in communication with and/or installed at the second party. According to some embodiments, the first and the second servers may share common features, such as an encryption methodology.

According to some embodiments, a first processor of the first server is configured to execute a code configured to receive a PII of a user of a first party. According to some embodiments, receiving the PII may include receiving the first party database from the first party. According to some embodiments, receiving the PII may include receiving a PII of a user in real time and substantially directly from the user (e.g., via a UI of the first server). Similarly, in some embodiments, a second processor of the second server is configured to execute a code configured to receive a PII of a user of a second party. According to some embodiments, receiving the PII may include receiving the second party database from the second party. According to some embodiments, receiving the PII may include receiving a PII of a user e.g., in real time and substantially directly from the user (e.g., via a UI of the first server). According to some embodiments, receiving the PII may include receiving a PII of a user in a later update of the first and/or second servers. In some embodiments, the PII of each user may not be transmitted from each of the first and second servers, thereby increasing the privacy of the user.

According to some embodiments, the first and/or the second party may determine a first and, optionally, a second set of rules configured to be executed by platform 100. According to some embodiments, the first and/or the second processors is configured to execute a code configured to receive and/or execute a first set of rules from the first and/or the second party, as elaborated in greater detail elsewhere herein. According to some embodiments, the first and/or the second processors server may be configured to execute a code configured to receive and/or execute a second set of rules from the first and/or the second party.

According to some embodiments, the first processor of the first server is configured to execute a code configured to generate a first anonymized ciphertext from the PII of the user of the first party. Similarly, in some embodiments, the second processor of the second server is configured to execute a code configured to generate a second anonymized ciphertext from the PII of the user of the second party. According to some embodiments, a PII of the same individual user received by each of the first and the second server is identical (e.g., the same phone number, the same email address, and the like, for the same individual user), to allow searching for a match between encrypted forms thereof.

According to some embodiments, the first ciphertext and/or the second ciphertext may be fully anonymized. According to some embodiments, the first ciphertext and/or the second ciphertext may be anonymized. In some embodiments, the first and/or the second server may be configured to transmit anonymized ciphertexts and, optionally, unencrypted data. As a non-limiting example, a user may log in into the second party by providing an email address, an ID, and gender thereof, and the second processor thereof may execute a code configured to generate a second ciphertext of the email address and a second ciphertext of the ID, while the gender may optionally be transmitted without generating a ciphertext therefrom.

According to some embodiments, each of the first and the second processors is configured to execute a code configured to transmit each of the first and second ciphertexts to the buffer platform, without transmitting the PII of the user.

According to some embodiments, a third process of the buffer server is configured to execute a code configured receive and store the first and the second ciphertexts, and to search for a match between the first and the second ciphertexts, to allow executing the first set of rules.

According to some embodiments, searching for the match includes comparing encrypted data (i.e., the first and the second ciphertexts).

In some embodiments, the buffer server is devoid of the PII received by the first and the second servers. Advantageously, in some embodiments, PII of a user of one of the parties may not be transmitted to other servers of platform 100. As a non-limiting example, a PII of a user of the first party, received by the first server, may not be transmitted to the buffer and the second servers of platform 100.

Advantageously, according to some embodiments, the first set of rules may be determined by the first party and executed for a user of a second party, without revealing the execution attempts to the first party. As a non-limiting example, a user may book/order a flight ticket via a flight company website, such that the airline may allow the user to pay with points of a credit card without knowing where the points came from. As another non-limiting example, two or more parties (e.g., companies) may identify mutual users/consumers to facilitate acquiring business insights (e.g., potential customers, priorities of the consumers, and the like), without sharing PII thereof. As another non-limiting example, two or more parties (e.g., companies) may identify mutual users/consumers and the preferences, interests and the like of the users, without sharing their PII, such that the privacy of the users is protected. As yet another non-limiting example, the second party may offer discounts, display advertisements, or provide any other commercial and/or customized content to mutual users of the first and the second party, without sharing the PII or any other data of users between the first and the second party (as the disclosed platform serves as a buffering layer).

Reference is now made to FIG. 1B, which schematically depicts a block diagram of platform 100, according to some embodiments. According to some embodiments, platform 100 is configured to enable performing transaction, interaction, or any other type of communication between two or more parties and/or users thereof.

According to some embodiments, and as depicted in FIG. 1B, platform 100 includes a first server 110, a second server 120, and a buffer server 130.

According to some embodiments, first server 110 may be in communication with a first party. According to some embodiments, first server 110 may be installed at the first party. According to some embodiments, first server 110 may be integrated into the first party. According to some embodiments, first server 110 may include a plurality of first servers, wherein each of the plurality of first servers is in communication with or installed at each of a plurality of first parties.

According to some embodiments, first server 110 includes a first processor (not shown). According to some embodiments, first server 110 may optionally include a memory, such as, for example, a non-transitory computer-readable storage medium.

According to some embodiments, the first processor of first server 110 is configured to execute a code configured to receive PII of a user(s) of the first party. According to some embodiments, first server 110 may be configured to receive the PII of users of the first party by receiving a first database of the first party. According to some embodiments, the first database of the first party may include PII of users thereof. According to some embodiments, first server 110 may receive an updated version of the first database of the first party. According to some embodiments, first server 110 may receive the first database and a segmentation of users thereof. As a non-limiting example, the first database may include PII of users and types of users, such as but not limited to, VIP users, and the like.

According to some embodiments, first server 110 may be configured to receive the PII of users of the first party by receiving a PII from a user in real time (e.g., via a user interface (UI)).

According to some embodiments, the first processor of first server 110 is further configured to execute a code configured to execute a first set of rules from the first party. According to some embodiments, the first set of rules may include any types of instructions that may be executed upon finding a match by buffer server 130, as elaborated in greater detail elsewhere herein. According to some embodiments, the first set of rules may include any type of instructions/acts that are allowed, by the first party, to be executed by or for the user of the first and the second party. According to some embodiments, the first set of rules received by first server 110 from the first party may be transmitted, by first server 110, to buffer server 130. According to some embodiments, the first det of rules may be provided substantially directly to buffer server 130.

According to some embodiments, the first processor of first server 110 may be configured to execute a code configured to execute a second set of rules from the first party. According to some embodiments, the second set of rules may include any types of instructions that may be executed if the match was not found by buffer server 130. As a non-limiting example, in a scenario in which a user of a second party may receive an offer from a first party without being a user/customer thereof (i.e., not a mutual user, the user is of the second party only), the match cannot be found, however, the second set of rules may be executed.

According to some embodiments, the first processor of first server 110 is further configured to execute a code configured to generate a first anonymized ciphertext from the PII of the user of the first party, as elaborated in greater detail elsewhere herein. According to some embodiments, the first ciphertext may include a plurality of first ciphertexts, so that each of the ciphertexts is configured to encrypt a different field of the PII of user. As a non-limiting example, the first ciphertext may include a first anonymized ciphertext of an email address of a user, a first anonymized ciphertext of an ID number, and/or a first anonymized ciphertext of a phone number, and the like.

According to some embodiments, the first anonymized ciphertext may include fully anonymized ciphertext of the PII. In some embodiments, the first anonymized ciphertext may include anonymized ciphertext and unencrypted data (e.g., by generating a ciphertext of a portion of fields of the PII).

According to some embodiments, the first processor of first server 110 is further configured to execute a code configured to transmit the first anonymized ciphertext from first server 110 to buffer server 130, such that transmitting the PII of the user of the first party is avoided. According to some embodiments, the first processor of first server 110 is further configured to execute a code configured to transmit the first anonymized ciphertext and, optionally, attach thereto metadata (e.g., dynamic metadata) indicating the segmentation of the user to buffer server 130.

According to some embodiments, second server 120 includes a second processor (not shown). According to some embodiments, second server 120 may optionally include a memory (not shown), such as, for example, a non-transitory computer-readable storage medium.

According to some embodiments, second server 120 may be in communication with a second party. According to some embodiments, second server 120 may be installed at the second party. According to some embodiments, second server 120 may be integrated into the second party. As a non-limiting example, second server 120 may be integrated into a self-checkout machine of the second party. According to some embodiments, second server 120 may include a plurality of second servers, wherein each of the plurality of second servers is in communication with or installed at each of a plurality of second parties.

According to some embodiments, the second processor of second server 120 is configured to execute a code configured to receive PII of a user(s) of the second first party. According to some embodiments, second server 120 may be configured to receive the PII of users of the second party by receiving a second database of the second party. According to some embodiments, the second database of the second party may include PII of users thereof. According to some embodiments, second server 120 may receive an updated version of the second database of the second party. According to some embodiments, second server 120 may receive the second database and a segmentation of users thereof. Alternatively, in some embodiments, the second party may be devoid of the second database.

According to some embodiments, second server 120 may be configured to receive the PII of users of the second party by receiving a PII from a user in real time (e.g., via a user interface (UI)).

According to some embodiments, the second processor of second server 120 is further configured to execute a code configured to execute a first and/or second set of rules. According to some embodiments, the set of rules may be determined by the second party. According to some embodiments, the set of rules may be set in buffer server 130. According to some embodiments, the set of rules may include any type of instructions/acts that are allowed, by the second party, to be executed by or for the user of the first and the second party.

According to some embodiments, the second processor of second server 120 is further configured to execute a code configured to generate a second anonymized ciphertext from the PII of users of the second party, as elaborated in greater detail elsewhere herein. According to some embodiments, the second ciphertext may include a plurality of second ciphertexts, so that each of the ciphertexts is configured to encrypt a different field of the PII of user.

According to some embodiments, the second anonymized ciphertext may include a fully anonymized ciphertext of the PII. According to some embodiments, the second anonymized ciphertext may include anonymized ciphertext and unencrypted data (e.g., by generating a ciphertext of a portion of fields of the PII).

According to some embodiments, the second processor of second server 120 is further configured to execute a code configured to transmit the second anonymized ciphertext server to buffer server 130, such that transmitting the PII of the user of the second party is avoided. According to some embodiments, the second processor of second server 120 is further configured to execute a code configured to transmit the second anonymized ciphertext and, optionally, attach thereto metadata (e.g., dynamic metadata) indicating the segmentation of the user to buffer server 130.

According to some embodiments, first server 110 and second server 120 may be substantially similar. According to some embodiments, first server 110 may differ from second server 120. According to some embodiments, first server 110 may differ from second server 120 in terms of hardware, software on any operating system of any firmware or a combination thereof. Each possibility is a separate embodiment. Alternatively, or additionally, in some embodiments, the common features of first server 110 and second server 120 may include hardware, software on any operating system of any firmware or a combination thereof.

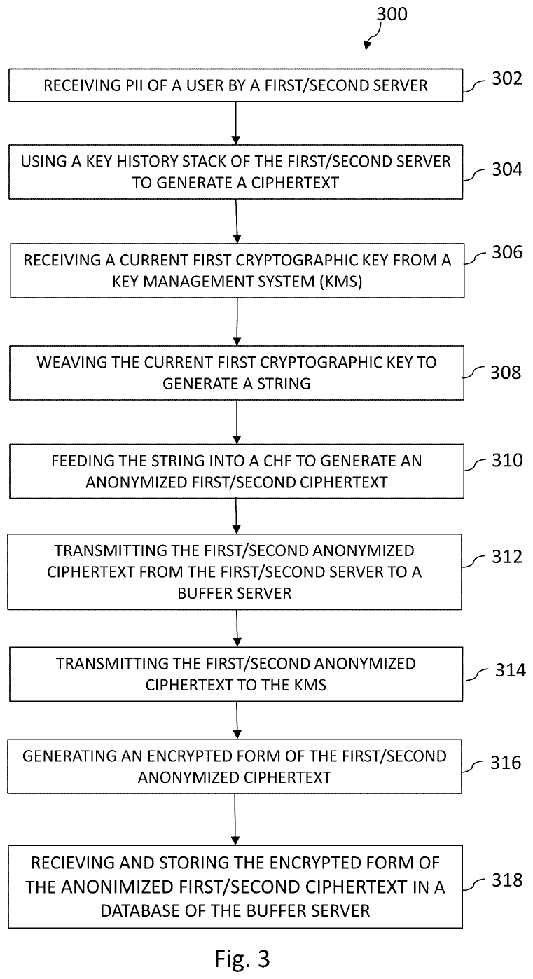

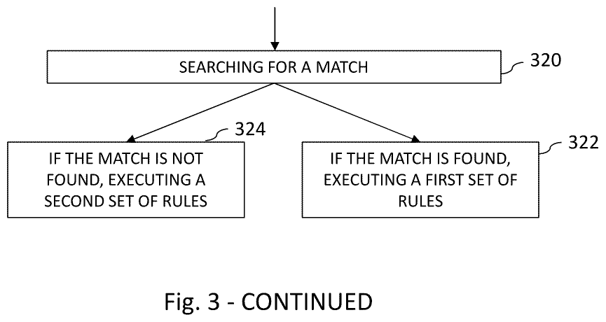

According to some embodiments, first server 110 and second server 120 may share or include common features. According to some embodiments, the common features may include, among others, encryption methodology, e.g., as elaborated in FIGS. 2 and 3. According to some embodiments, the common features may include, among others, common PII of an individual user. As a non-limiting example, an email address and/or a phone number of a user received by first server 110 may be identical to the email address and/or the phone number of the same user receiving by second server 120.

According to some embodiments, each of first and second processors of first server 110 and second server 120 are configured to generate the same ciphertext from each single field of PII of a user, thereby maintaining deterministic encryption methodology. Put differently, the first ciphertext generated by first server 110 is configured to match (e.g., be equal to) the second ciphertext generated by second server 120 for the same individual user.

According to some embodiments, first and second processors of first server 110 and second server 120 may be configured to execute a code configured to generate each of the first and second anonymized ciphertext, respectively, by using a cryptographic hash function (CHF) methodology, thereby obtaining substantially irreversible cyphertexts.

According to some embodiments, first and second processors of first server 110 and second server 120 may be configured to execute a code configured to generate each of the first and second anonymized ciphertext, respectively, by using an asymmetric encryption method. According to some embodiments, the asymmetric encryption method may include, among others, RSA, McEliece cryptosystem, ElGamal encryption system, and the like. In some embodiments, the asymmetric encryption method may include, among other, Diffie—Hellman key exchange protocol. In some embodiments, the asymmetric encryption method may enable resolving a possible dispute between a user and the first and/or the second party. As a non-limiting example, a dispute may be resolved by restoring a record of money transaction to/from the user.

According to some embodiments, each of first and second processors of first server 110 and second server 120 may be configured to execute a code configured to use a key history stack of each of the first and the second servers 110 and 120, respectively, to generate each of the first and second anonymized ciphertexts, as elaborated in greater detail elsewhere herein.

According to some embodiments, first server 110 may include a UI for interacting with a user and/or with the first party. Similarly, in some embodiments, second server 120 may include a UI for interacting with a user and/or with the second party. According to some embodiments, each of the UI may interact with each of the first and the second processor, respectively. According to some embodiments, each of the UI may include one or more of: a touch screen, a screen connected to a keyboard and/or a mouse, a joystick, or any other type of interface for interacting with a user. As a non-limiting example, first server 110 and/or second server 120 may be in communication with online stores, self-checkout machines, and the like. In some embodiments, private user-related information (i.e., PII of a user) may not leave a website of a merchant.

According to some embodiments, buffer server 130 includes a third processor (not shown). According to some embodiments, buffer server 130 may optionally include a memory (not shown), such as, for example, a non-transitory computer-readable storage medium.

According to some embodiments, buffer server 130 may be in communication (e.g., via a secured communication protocol) with first server 110 and with second server 120. According to some embodiments, buffer server 130 may be in communication with a key management system (KMS) 140 of platform 100, as elaborated in greater detail elsewhere herein.

According to some embodiments, buffer server 130 is configured to execute a code configured to receive and store the first anonymized ciphertext from the first server and the second anonymized ciphertext from the second server.

According to some embodiments, buffer server 130 may include a buffer server database. According to some embodiments, the buffer server database is configured to store the first and/or the second ciphertexts, as elaborated in greater detail elsewhere herein.

According to some embodiments, buffer server 130 is further configured to execute a code configured to search for a match between the first and the second anonymized ciphertexts, thereby allowing performing a transaction/interaction between the first and the second party without transmitting the PII of users therebetween.

According to some embodiments, searching for the match may include searching for equality between the first anonymized ciphertext and the second anonymized ciphertext to allow performing the transaction/interaction. It may be understood by the skilled in the art, that the disclosed methodology is deterministic, and hence the same PII of the same individual user may result in generating substantially equal first and second anonymized ciphertexts at each of first and second servers 110 and 120.

According to some embodiments, searching for the match may include searching for correspondence between the first anonymized ciphertext and the second anonymized ciphertext to allow performing the transaction/interaction. As a non-limiting example, prior to being transmitted to buffer server 130, the first anonymized ciphertext may be inputted into a function, an algorithm, and the like, to encrypt, or otherwise process (e.g., apply thereto a predetermined mathematical set of rules/actions, and the like) thereof, such that the first anonymized ciphertext transmitted to buffer server 130 may not be equal to the second anonymized ciphertext transmitted to buffer server 130 from second server 120, while each of the first and the second anonymized ciphertexts are deterministic and represent the same PII of the same user.

According to some embodiments, if the match is found, buffer server 130 may be further configured to execute a code configured to execute the first set of rules defined by the first and/or the second party, such that execution attempts of the first set of rules are unknown to the first or the second party.

According to some embodiments, if the match is found, first server 110 and/or second server 120 may be further configured to execute a code configured to execute the first set of rules. In some embodiments, the first set of rules may be set in buffer server 130.

According to some embodiments, if the match is not found, buffer server 130 may be configured to execute a code configured to execute a second set of rules defined by the first and/or the second party. According to some embodiments, execution attempts of the second set of rules may be unknown to the first or to the second party.

According to some embodiments, if the match is not found, first server 110 and/or second server 120 may be further configured to execute a code configured to execute the second set of rules. According to some embodiments, the second set of rules may be set in buffer server 130.

According to some embodiments, buffer server 130 may not receive or be otherwise be exposed to the PII of users of the first and the second party, thereby protecting the privacy of the users and the costumers.

According to some embodiments, buffer server 130 may be configured to enable backward compatibility of platform 100, as elaborated in greater detail elsewhere herein. According to some embodiments, buffer server 130 may be configured to execute a code configured to update the encryption methodology of first server 110 and second server 120.

According to some embodiments, buffer server 130 may be configured to execute a code configured to generate performance data of platform 100. According to some embodiments, performance data may include, among others, a record of user requests, statistical information related to users' requests, operation-related data of platform 100, and the like. According to some embodiments, the performance data may be based on encrypted data (e.g., the first and/or the second ciphertexts), thereby protecting the privacy of users. According to some embodiments, the performance data may include, among others, sum of the executed transaction, offer types (e.g., discounts and the like), store types, or any other anonymized data regarding users or issuers of the offers (e.g., the first/second party).

According to some embodiments, master/privileged users of platform 100 may have access to buffer server 130. According to some embodiments, the master/privileged users may have access to, among others, the performance data generated by buffer server 130. According to some embodiments, buffer server 130 may include a UI (not shown) configured to allow communication between the master/privileged users and buffer server 130. As a non-limiting example, the master/privileged users may set up a first and/or a second set of rules in buffer server 130 to be executed (e.g., by second server 120) after searching for the match is performed.

According to some embodiments, the master/privileged users may request a third processor of the buffer server may execute a code configured to retrieve a current cryptographic key used by the first and the second servers (as elaborated in FIGS. 2-3), thereby creating and, optionally, storing, a detailed log thereof, i.e., recording at least a portion and/or all of access requests performed by users of the disclosed platform.

According to some embodiments, platform 100 may include a key management system (KMS) 140. According to some embodiments, and as schematically depicted in FIG. 1B, KMS 140 may be external to first server 110, second server 120 and buffer server 130. Alternatively, in some embodiments, buffer server 130 may include KMS 140 (embodiment not depicted).

According to some embodiments, KMS 140 may be in communication (e.g., via a secured network, platform, and the like) with each of first server 110, second server 120 and buffer server 130. According to some embodiments, KMS 140 is configured to generate a first cryptographic key for each of the PII of users. In some embodiments, KMS 140 is configured to generate the first cryptographic key and transmit it to each of first server 110 and second server 120. According to some embodiments, each of the processors of the first and the second servers 110 and 120 is configured to apply an encryption methodology, as elaborated in FIG. 2-3, and use the first cryptographic key to generate the first and the second anonymized (or fully anonymized) ciphertexts.

According to some embodiments, a different first cryptographic key may be generated and transmitted to the first and the second server 110 and 120 for each PII of a user (i.e., different cryptographic keys may be used to encrypt PII of different users, while the same cryptographic key is used for the same individual user at the first and the second servers to maintain deterministic encryption). Alternatively, in some embodiments, the same first cryptographic key may be used to generate the first anonymized ciphertext at server 110 and the second anonymized ciphertext at server 120, for all users, at each iteration of the encryption methodology (i.e., each iteration of generating a ciphertext by first and second servers 110 and 120 may be executed by using the same first cryptographic key, as elaborated in greater detail elsewhere herein). In some embodiments, the same (previously used) first cryptographic key may be used to generate the first and the second database of first and second severs 110 and 120.

According to some embodiments, each of first and second servers 110 and 120 may include a history stack. According to some embodiments, the history stack includes previously used first cryptographic keys. According to some embodiments, the history stack includes previously used first cryptographic keys and weaving rules thereof, as elaborated in FIGS. 2-3.

According to some embodiments, KMS 140 is configured to generate and transmit a new first cryptographic key to each of the first and second servers 110 and 120.

According to some embodiments, each of first and second servers 110 and 120 may be configured to execute a code configured to update each of the key history stack thereof. According to some embodiments, updating the key history stack may include: generating (e.g., by KMS 140) a new (also referred to as “current”) first cryptographic key, transmitting the new first cryptographic key to the first and the second servers, and storing a previously used first cryptographic key and the rules for weaving thereof in the key history stack of each of the first server and the second server, thereby enabling backwards compatibility.

According to some embodiments, the first cryptographic key may be generated by KMS 140 and transmitted to each of the first and the second servers 110 and 120. According to some embodiments, the first cryptographic key may include a cryptographic salt. According to some embodiments, the first cryptographic key may include a secret cryptographic salt. According to some embodiments, the cryptographic salt may be generated by KMS 140 by using, for example, random values of temperature change of a processor. According to some embodiments, the cryptographic salt may be generated by KMS 140 based, at least in part on, for example, coordinates of mouse movement, or derivates thereof. It may be understood by the skilled in the art that generating the first cryptographic key may include implementing various methods yielding substantially a random set of characters of the cryptographic key.

According to some embodiments, KMS 140 may generate the first cryptographic key by generating a Rivest—Shamir—Adleman (RSA) asymmetric key pair. As a non-limiting example, KMS 140 may include or be in communication with an Amazon web services (AWS) platform to generate the RSA asymmetric key pair. It may be understood by the skilled in the art an RSA asymmetric key pair includes a pair of a private key and a public key. According to some embodiments, the private key generated by KMS 140 may be deleted substantially immediately after generation thereof, while the public key may be utilized as the first cryptographic key. As a non-limiting example, the first cryptographic key generated by KMS 140 may include an RSA 4096 asymmetric key. According to some embodiments, the public RSA key may be advantageously used as a unique set of characters, as elaborated in greater detail elsewhere herein, in contrast to the conventional use thereof as an encryption key.

According to some embodiments, KMS 140 may include a hardware security module (HSM).

According to some embodiments, KMS 140 is configured to generate a second cryptographic key, as elaborated in greater detail in FIG. 3. According to some embodiments, the second cryptographic key may be generated by similar method as the first cryptographic key. According to some embodiments, the second key is stored in KMS 140 without being transmitted therefrom (i.e. a restricted access key). In some embodiments, the master/privileged users of platform 100 may not have access to a second cryptographic key generated by KMS 140.

According to some embodiments, buffer server 130 may include a persistency manager system (not shown). According to some embodiments, the persistency manager system may be configured to maintain continuity thereof and minimize and/or substantially avoid data loss (e.g., in a scenario of a key swap). According to some embodiments, the persistency manager system may be configured to monitor and save each request from first server 110 and/or second server 120 to receive a first cryptographic key. According to some embodiments, the persistency manager system may be configured to monitor and save each request from buffer server 130 generate a second cryptographic key.

According to some embodiments, a fourth processor of the persistency manager system may be configured to execute a code configured to alert buffer server 130 in a scenario of a suspicious activity (e.g., an attempt to attack or access platform 100). According to some embodiments, the fourth processor of the persistency manager system may be configured to execute a code configured to trigger actions to deprecate the first cryptographic key used by first and second servers 110 and 120, and request to generate a new first cryptographic key (i.e., request to execute a key swap operation). According to some embodiments, the fourth processor of the persistency manager system may be configured to execute a code configured to trigger actions to deprecate the second cryptographic key used by buffer server 130, and request to generate a new second cryptographic key (i.e., request to execute a key swap operation). According to some embodiments, the fourth processor of the persistency manager system may be configured to execute a code configured to add the deprecated first key of first and second servers 110 and 120 to the key history database thereof, thereby updating the key history stack. According to some embodiments, the fourth processor of the persistency manager system may be configured to execute a code configured to request/initiate the key swap operation.

Advantageously, in some embodiments, platform 100 is configured to facilitate substantially seamlessly replacing the current first cryptographic key generated by KMS 140, without redeeming previously generated ciphertexts by each of first and second servers 110 and 120, which, in turn, enables platform continuity.

Advantageously, in some embodiments, platform 100 is configured to enable a key swap substantially without losing data. Put differently, in some embodiments, a new cryptographic key may be generated each time a current cryptographic key is compromised. In some embodiments, the new cryptographic key may be used without redeeming the previously used cryptographic key (e.g., the previously used cryptographic key may be stored in the key history stack), thereby enabling continuity and backwards compatibility.

According to some embodiments, first server 110 may be remote from second server 120. According to some embodiments, each of first server 110, second server 120 and buffer server 130 may be remote from one another.

Reference is made to FIG. 2, which shows a flowchart of a computer implemented method for performing securing interaction, communication, transaction, and the like, between two or more parties.

According to some embodiments, at step 202, the method may include receiving PII of a user by a first server. According to some embodiments, the PII of the user may be transmitted to the first server from a first party (e.g., by transmitting a first party database). According to some embodiments, the user may communicate in real-time with the first server. As a non-limiting example, the user may log in or otherwise insert the PII into the first server.

According to some embodiments, at step 204, the method may include generating a first anonymized ciphertext from the PII of the user.

According to some embodiments, the first anonymized ciphertext may be generated, based at least in part on, using a cryptographic hash function (CHF). Consequently, in some embodiments, the first anonymized ciphertext may be substantially irreversible. Put differently, in some embodiments, using the CHF may result in substantially impossible or very difficult (e.g., time and recourse consuming) to restore the PII therefrom, while enabling searching for a match between the first and a second anonymized ciphertexts without sharing the PII of the user. As a non-limiting example, a first processor of the first server may be configured to execute a code configured to use a SHA-256 or SHA-512 function to calculate/generate a hash value of the inputted data (e.g., the PII of the user, or a different ciphertext/string, as elaborated in FIG. 3). It may be understood by the skilled in the art, that performing minor modifications to the input data into the CHF may result in outputting a significantly different hash value generated therefrom.

According to some embodiments, the first anonymized ciphertext may be generated, based at least in part on, using asymmetric encryption methods, such as but not limited to, RSA, ElGamal, McEliece, and the like. Consequently, in some embodiments, enabling restoring a transaction record (e.g., a money transaction record) to resolve a dispute.

According to some embodiments, generating the first anonymized ciphertext may include generating a unique string including characters of the PII of the user and characters of a first cryptographic key, based on weaving characters of the cryptographic key into characters of PII of a user or into encrypted data (e.g., an intermediate ciphertext, as elaborated in greater detail elsewhere herein), and feeding the string into the CHF.

According to some embodiments, generating the first anonymized ciphertext may include generating a first cryptographic key by a KMS and transmitting thereof to the first and the second server. According to some embodiments, the first cryptographic key may include a secret cryptographic salt. According to some embodiments, the cryptographic key may include a public RSA 4096 key.

According to some embodiments, generating the first anonymized ciphertext may include weaving the first cryptographic key into the PII of the user to generate a string. According to some embodiments, weaving may include concatenating the first cryptographic key with the PII, to mitigate hash table attacks. Put differently, weaving may include joining end-to-end characters of the cryptographic key with characters of the PII. According to some embodiments, weaving may include applying place permutation to places of characters of the PII of the user and to places of characters of the first cryptographic key. According to some embodiments, weaving may include positioning characters of the cryptographic key into the characters of the PII. According to some embodiments, the string includes the characters of the first cryptographic key weaved into the characters of the PII of the user. According to some embodiments, the KMS may be configured to generate different weaving rules for each of the first cryptographic keys.

According to some embodiments, the first processor of the first server may be configured to execute a code configured to use a key history stack of the first server, thereby increasing security by increasing the resistance to attacks thereto (e.g., dictionary attacks), enabling continuity and backwards compatibility thereof. According to some embodiments, the key history stack of the first server may include each of previously used cryptographic keys and corresponding weaving rules thereby, thereby enabling encrypting the PII of the user a plurality of times (i.e., executing a plurality of iterations). Each string generated by each of the previously used cryptographic keys and the corresponding weaving rules may be fed into the CHF, to generate a ciphertext. The ciphertext is, in turn, weaved with a next previously used cryptographic key and the corresponding weaving rules thereof.

Put differently, in some embodiments, generating the first anonymized ciphertext may include using the key history step to iteratively encrypt the PII of the user to generate a ciphertext, and then the KMS may generate and transmit a new/current cryptographic key and optionally weaving rules thereof to the first server. In some embodiments, the first process of the first server may be configured to execute a code configured to generate the weaving rules. Then, the new/current cryptographic key is weaved into the ciphertext according to the weaving rules thereof, thereby generating a string. According to some embodiments, feeding the string to the CHF results in generating the first ciphertext in the first server.

According to some embodiments, in step 206, the method may include transmitting the first anonymized ciphertext from the first server to a buffer server of the platform, such that the PII of the users is not transmitted therefrom.

According to some embodiments, steps 202-206 may be performed in real time (e.g., by a user via a UI of the first party). In some embodiments, steps 202-206 may be performed at predefined time constants by the first party (e.g., during a batch update, without user interaction with the first party and/or the first server).

According to some embodiments, in step 208, the method may include receiving a PII of a user(s) of a second party. According to some embodiments, the PII of the user(s) of the second party may be received from the second party (e.g., by transmitting a second database of PII of users thereof to the second server). According to some embodiments, the PII of the user(s) of the second party may be received for an individual user, e.g., in real time, by communicating with the second server. As a non-limiting example, a user of the second party may communicate with the second server via a UI.

According to some embodiments, in step 210, the method may include generating a second anonymized ciphertext. According to some embodiments, the second anonymized ciphertext may be a fully anonymized ciphertext. According to some embodiments, step 210 may be substantially similar to step 204, to allow searching for a match between the first anonymized ciphertext and the second anonymized ciphertext. According to some embodiments, the first ciphertext is configured to be equal to the second ciphertext for the same PII of the same individual user. It may be understood by the skilled in the art that the discloses method is deterministic, thereby enabling searching for the match without sharing the PII of users of each of the first and the second parties.

According to some embodiments, in step 212, the method may include transmitting the second anonymized ciphertext from the second server to the buffer server. According to some embodiments, the second anonymized ciphertext may be transmitted to the buffer server via a secured network communication system.

According to some embodiments, in step 214, the method may include receiving and storing each of the first and the second anonymized ciphertexts in the buffer server. According to some embodiments, each of the first and the second anonymized ciphertexts may be stored in a buffer database. According to some embodiments, the first and the second ciphertexts may be encrypted prior to being stored in the buffer database. According to some embodiments, the buffer database may be updated. As a non-limiting example, the buffer database may be updated upon detecting an attack attempt to the platform and/or any servers thereof.

According to some embodiments, in step 216, the method may include searching for a match between the first and the second ciphertexts. According to some embodiments, searching for the match may include searching for equality between the first and the second ciphertext.

According to some embodiments, searching for the match may include searching for correspondence between the first and the second ciphertext, as elaborated elsewhere herein.

According to some embodiments, if the match was found, the method may further include executing a first set of rules. According to some embodiments, the first set of rules may be determined by the first party and/or the second party. According to some embodiments, attempts to execute rules may not be known to the party determining the first set of rules.

In some embodiments, the execution of the first set of rules may be restored, if required (e.g., when an asymmetric encryption method was used to generate each of the first and the second anonymized ciphertexts). In some embodiments, the execution of the first set of rules may not be restored (e.g., when a CHF-based encryption method was used to generate each of the first and the second anonymized ciphertexts).

Reference is made to FIG. 3, which shows a flowchart of an example of a method for performing secured interaction/communication between two or more parties.

According to some embodiments, in step 302, the method may include receiving a PII of a user. According to some embodiments, the PII of the user may be received by a first or a second server. As a non-limiting example, the user may provide an email address, and/or a phone number, or any other type of user-related information to the first or the second server.

According to some embodiments, in step 304, the method may include using a key history stack of the first or the second server to generate an intermediate ciphertext of the PII of user.

According to some embodiments, generating the intermediate ciphertext may include using the history stack of the first server to encrypt the PII. According to some embodiments, generating the ciphertext may include using the history stack of the second server to encrypt the PII. According to some embodiments, the history stack comprises previously used cryptographic keys and weaving rules of each of the keys. Specifically, in some embodiments, using the history stack may include generating an intermediate ciphertext N times (i.e., performing one or more iterations of encryption by using the key history stack), wherein each of the one or more iterations includes a previously used cryptographic key and the corresponding weaving rules thereof.

According to some embodiments, using the history stack may include weaving a previously used cryptographic key into the PII of the user (in a first iteration) or into an intermediate ciphertext (in the following iterations). According to some embodiments, each weaving is performed according to the corresponding previously used cryptographic key and corresponding weaving rules thereof stored at the key history stack.

According to some embodiments, the weaving may include concatenation of a previously used cryptographic key with the PII of user (or with a corresponding ciphertext, depending on the number of the executed iteration). According to some embodiments, the weaving may include performing place permutation of characters of the PII of user (or of a corresponding ciphertext, depending on the number of the executed iteration) and a previously used cryptographic key. According to some embodiments, the weaving may include performing weaving of characters of the PII of the user (or a corresponding ciphertext, depending on the number of the iteration) into characters of a corresponding cryptographic key. According to some embodiments, the weaving rules for each of the previously used cryptographic keys may be different.

According to some embodiments, each weaving is configured to generate a string. According to some embodiments, the sting may include characters of the PII of the user and characters of the cryptographic key (e.g., in the first iteration). According to some embodiments, the string may include characters of each of the intermediate ciphertext and characters of the corresponding previously used cryptographic key.

According to some embodiments, the string may be fed into a CHF, to generate an intermediate ciphertext therefrom (i.e., of the first iteration). According to some embodiments, the generated intermediate ciphertext is configured to be weaved with a next previously used cryptographic key and corresponding weaving rules thereof stored in the key history stack (i.e., undergo a next iteration), thereby encrypting the ciphertext. According to some embodiments, the ciphertext may be iteratively encrypted until all of the history stack is used.

According to some embodiments, in step 306, the method may include receiving a current first cryptographic key by the first or the second server. According to some embodiments, the current first cryptographic key may be generated by a KMS and transmitted to the first and the second server.

According to some embodiments, the first cryptographic key and corresponding weaving rules thereof used at each of the first and the second servers are identical, to generate equal first and second ciphertexts for the same PII of the same individual user.

According to some embodiments, the history stack of each of the first and the second servers may be devoid of the current cryptographic key, thereby enhancing platform security. Put differently, in some embodiments, the current first cryptographic key may not be stored in each of first and second servers.

According to some embodiments, in step 308, the method may include weaving the current cryptographic key into the intermediate ciphertext. According to some embodiments, the current cryptographic key may be weaved into the PII of the user (e.g., in a scenario in which the server is devoid of a history stack, or in a scenario in which the history stack is empty).

According to some embodiments, the weaving may include concatenation of the current cryptographic key with the PII of user. According to some embodiments, the weaving may include concatenation of the cryptographic key with the intermediate ciphertext. According to some embodiments, the weaving may include concatenation of a cryptographic key with the PII of user. According to some embodiments, the weaving may include performing place permutation of characters of the PII of user (or the intermediate ciphertext) and the current cryptographic key. According to some embodiments, the weaving may include performing weaving of characters of the PII of the user (or of the ciphertext) into characters of the current cryptographic key, thereby generating a string.

According to some embodiments, in step 310, the method may include feeding the string into the CHF, thereby generating an anonymized first or ciphertext by the first or second server, respectively. According to some embodiments, the CHF may include, among others, SHA-1, SHA-2, SHA-3, MD4, MD5, MD6 or any other type of cryptographic protocols based on hash functions.

According to some embodiments, in step 312, the method may include transmitting the first anonymized ciphertext from the first server to a buffer server. According to some embodiments, in step 312, the method may include transmitting the second anonymized ciphertext from the second server to the buffer server. According to some embodiments, the first and/or the second anonymized ciphertext may be transmitted from the first and/or the second server, respectively, to the buffer server by using a secured communication protocol, network, system, and the like.

According to some embodiments, in step 314, the method may include transmitting the first and/or second anonymized ciphertext from the buffer server to the KMS.

According to some embodiments, in step 316, the method may include generating an encrypted form of the first and/or the second ciphertexts in the KMS.

According to some embodiments, step 316 may include generating, by the KMS, a second cryptographic key. As a non-limiting example, the second cryptographic key may be an RSA 4096 public key. According to some embodiments, the KMS is configured to store the second cryptographic key therein without transmitting thereof. Put differently, the buffer server may be devoid of the second cryptographic key. In some embodiments, master users of the platform may be devoid of access to the second cryptographic key.

According to some embodiments, step 316 may further include weaving the second cryptographic key into the first/second anonymized ciphertext, in the KMS, thereby generating a second string. According to some embodiments, the second string may include characters of the first/second anonymized ciphertext and characters of the second cryptographic key. According to some embodiments, the buffer server may be devoid of the second cryptographic key and of weaving rules used to weave the second cryptographic key into the first/second anonymized ciphertexts.

According to some embodiments, step 316 may further include feeding the second string into the CHF, thereby generating an encrypted form of the first/second anonymized ciphertext.

According to some embodiments, in step 318, the method may include transmitting the encrypted form of the first/second anonymized ciphertext from the KMS to the buffer server. According to some embodiments, in step 318, the method may include storing the encrypted form of the first/second anonymized ciphertext in a buffer database. According to some embodiments, the method may include updating the buffer database. Consequently, in some embodiments, enabling backward compatibility, and minimizing/preventing dictionary attacks.

According to some embodiments, step 318 may optionally include encrypting the encrypted form of the first/second anonymized ciphertext received from the KMS prior to storing thereof in the buffer database. According to some embodiments, the encryption may include, among others, applying an AES methodology thereto. According to some embodiments, the buffer server may generate and store cryptographic keys of the AES methodology. As a non-limiting example, buffer server may include Atlas Mongo database platform configured to encrypt the buffer database.

According to some embodiments, in step 320, the method may include searching for a match between the first ciphertext and the second ciphertext received from the first server and the second server, respectively. According to some embodiments, the method may include searching for the match between the encrypted forms of the first and the second ciphertexts. According to some embodiments, searching for the match may include searching for equality between the first and the second anonymized ciphertexts. According to some embodiments, searching for the match may include searching for correspondence between the first and the second anonymized ciphertexts, as elaborated elsewhere herein.

According to some embodiments, in step 322, the method may optionally include executing a first set of rules. According to some embodiments, the first set of rules may be determined by the first and/or the second party. According to some embodiments, execution attempts of the first set of rules for a user of the second party may be unknown to the first party. According to some embodiments, execution attempts of the first set of rules a user of a first party may be unknown to the second party. As a non-limiting example, a second party may advertise a discount for an item for users of a first party (i.e., for mutual users of the first and the second party), hence, in some embodiments, if the user has not purchased the item, exposing the user to the discount may not be revealed or otherwise shared with the first server and the first party.

According to some embodiments, in step 324, the method may optionally include executing a second set of rules, if the match was not found. According to some embodiments, the second set of rules may be determined by the first and/or the second party. According to some embodiments, execution attempts of the second set of rules by the buffer server for a user of the second party may be unknown to the first party. According to some embodiments, execution attempts of the second set of rules by the buffer server for a user of a first party may be unknown to the second party. As a non-limiting example, in a scenario in which the first party is interested in offering an incentive/offer to individuals who are not users/consumers thereof, hence the match is not found, and the second set of rules may be executed to make the offer.

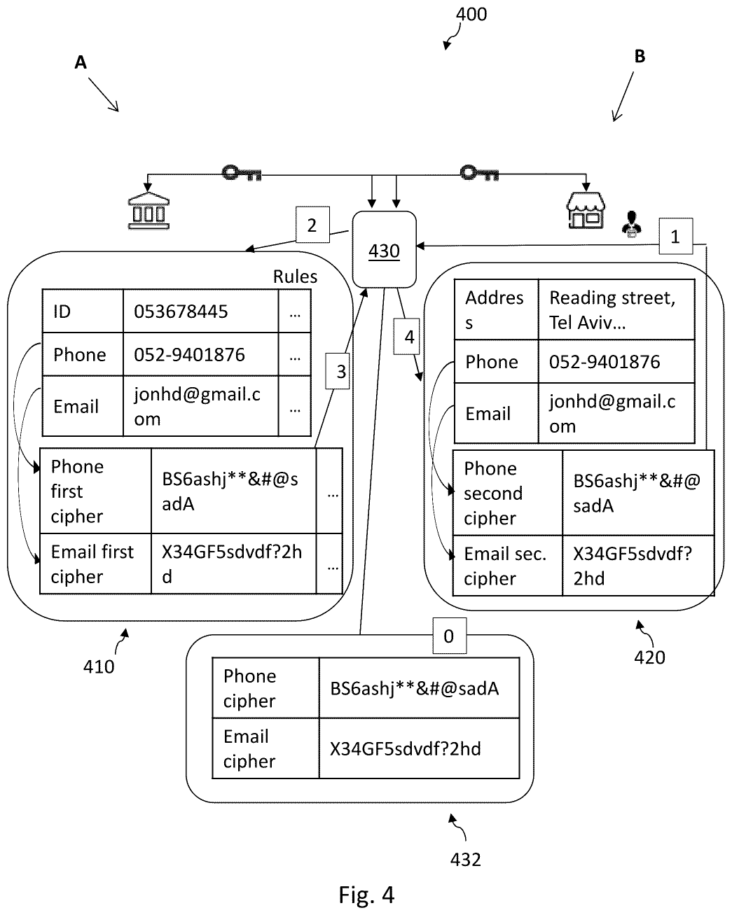

Reference is made to FIG. 4, which schematically depicts an example of method for performing interaction, transaction, or any other type of communication by a platform 400, between a first party (marked as “A”) and a second party (marked as “B”), according to some embodiments.

According to some embodiments, platform 400 includes a first server 410, a second server 420 and a buffer server 430.

According to some embodiments, first server 410 may include a first processor configured to execute a code configured to: receive a PII of a user of the first party, generate a first anonymized ciphertext, and transmit the first anonymized ciphertext to buffer server 430, e.g., as elaborated in greater detail in FIG. 2.

In some embodiments, first server 410 may receive a first database from the first party. According to some embodiments, the first database may include a PII of each user of the first party, as schematically depicted in FIG. 4, the first database may include a portion of PII of users of the first party. According to some embodiments, the first database may include a PII of each user of the first party and a segmentation thereof. Alternatively, or additionally, in some embodiments, a PII of a user may be received, in real time, by the user (e.g., via a UI of the first server). According to some embodiments, and as schematically depicted in FIG. 4, PII of users of the first party may include an ID number, a phone number, and an email address of a user. According to some embodiments, and as schematically depicted in FIG. 4, first anonymized ciphertext generated by first server 410 may include a first anonymized ciphertext of the phone number and a first anonymized ciphertext of the email address of the user.

According to some embodiments, the first party may determine and transmit to the first server a first set of rules. According to some embodiments, the first set of rules may be transmitted to buffer server 430. According to some embodiments, the first set of rules includes actions the platform is configured to execute on behalf of, e.g., the first party, upon finding the match. According to some embodiments, the first set of rules may be updated on an ongoing basis.

According to some embodiments, a second processor of second server may be configured to execute a code configured to: receive a PII of a user of the second party, generate a second anonymized ciphertext, and transmit the second anonymized ciphertext to buffer server 430.

According to some embodiments, and as schematically depicted in FIG. 4, PII of users of the second party may include an address, a phone number, and an email address of a user. According to some embodiments, and as schematically depicted in FIG. 4, second anonymized ciphertext generated by first server 420 may include a second anonymized ciphertext of the phone number and a second anonymized ciphertext of the email address of the user.

According to some embodiments, first and second servers 410 and 420 may share common features, as elaborated in greater detail elsewhere herein.

According to some embodiments, a third processor of buffer server 410 may be configured to execute a code configured to receive and store the first and the second anonymized ciphertexts.

According to some embodiments, and as schematically depicted in FIG. 4, the third processor of buffer server 430 may be configured to receive and store the first anonymized ciphertext from first server 410. According to some embodiments, the first anonymized ciphertext may be stored in a buffer database 432.

According to some embodiments, prior to storing the first anonymized ciphertext in buffer database 432, the first anonymized ciphertext may be encrypted, to increase resistance of platform 400 to attacks. According to some embodiments, the third processor of buffer server 430 may be configured execute a code configure to transmit the first anonymized ciphertext to an KMS (e.g., KMS 140 depicted in FIG. 1B). According to some embodiments, the KMS may be external to buffer server 430. According to some embodiments, the KMS may optionally be positioned internally within buffer server 430. According to some embodiments, the KMS may be configured to generate a second cryptographic key, the second cryptographic key is stored in the KMS. Put differently, in some embodiments, the second cryptographic key may be unknown to buffer server 430. According to some embodiments, the second cryptographic key may not be retrievable from the KMS. According to some embodiments, the KMS may be configured to generate an encrypted form of the first anonymized ciphertext, e.g., by weaving the second cryptographic key into the first anonymized ciphertext, as elaborated in greater detail elsewhere herein.

According to some embodiments, a user or a consumer may share PII thereof with second server 420 of a second party in real time. According to some embodiments, during the real-time activity of the consumer at the second server, the second processor of second server 420 may be configured to execute a code configured to generate the second anonymized ciphertext from the PII of the user. According to some embodiments, the second server is configured to execute a code configured to generate the second anonymized ciphertext from the PII of the user by using asymmetric encryption methodology (e.g., an RSA protocol). According to some embodiments, second server 420 may configured to execute a code configured to transmit the second ciphertext to the buffer server 430.

According to some embodiments, in step 0, the third processor of buffer server 430 may be configured to execute a code configured to receive the first anonymized ciphertext and store thereof in buffer database 432.

According to some embodiments, in step 1, the method may include receiving the second anonymized ciphertext by buffer server 430 from second server 420. According to some embodiments, the step may optionally include storing the second anonymized ciphertext in buffer database 432.

According to some embodiments, in step 2, the method may optionally include asking first server 410 for the first anonymized ciphertext. According to some embodiments, the first ciphertext may be stored in buffer database 432. According to some embodiments, in step 2, the method may include asking first server 410 for a first set rules, wherein the first set of rules is configured to be executed upon finding a match. According to some embodiments, in step 2, the method may include asking first server 410 for a second set of rules, wherein the first set of rules is configured to be executed if the match is not found.

According to some embodiments, in step 3, the method may include receiving the first anonymized ciphertext and optionally the first and/or the second set of rules from first server 110.

According to some embodiments, in step 3, the method may include searching for a match between the second anonymized ciphertext and the first anonymized ciphertext. According to some embodiments, searching for the match may include searching for a match between the first/second anonymized ciphertext received in real-time from the user and buffer database 432 of the second/first anonymized ciphertexts, respectively. According to some embodiments, searching for the match may include substantially searching for equality between the first and the second anonymized ciphertexts.

According to some embodiments, in step 4, if the match is found, the buffer server 430 may be configured to execute the first set of rules determined by the first party. According to some embodiments, in step 4, if the match is found, second server 420 may be configured to execute the first set of rules.

According to some embodiments, if the match is not found, the buffer server may be configured to execute a second set of rules determined by the first party.

According to some embodiments, in step 4, executing the first set of rules may include providing or authorizing offers/services to the user.

According to some embodiments, the user may, optionally, choose to notify the first party regarding the offers/services received from the second party.

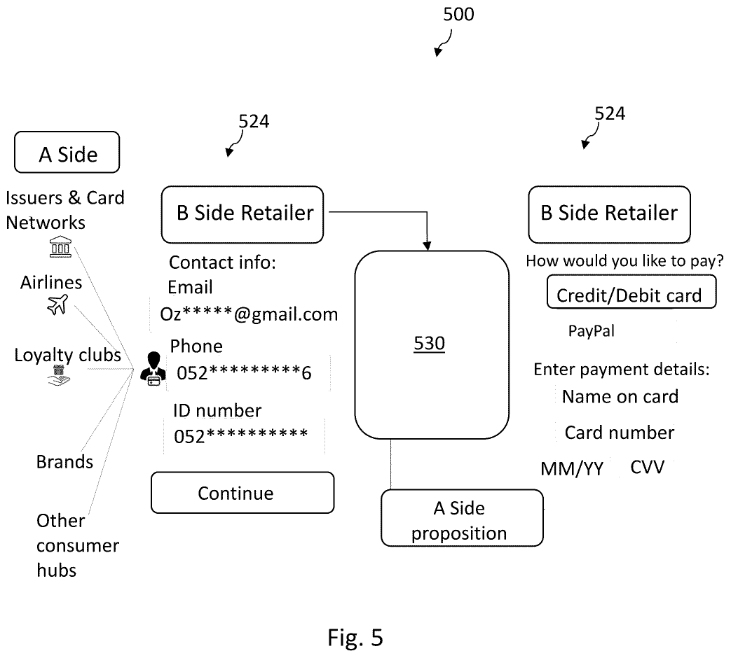

FIG. 5 schematically depicts an example of a method for performing transaction/communication by utilizing a platform 500 in e-commerce, according to some embodiments.

According to some embodiments, a first party (marked as “A side”) may refer to airlines, loyalty clubs, brands, credit card companies, insurance companies, card networks or any other consumer hubs. Each possibility is a separatee embodiment.

According to some embodiments, a first server (not shown) may be in communication with the first party.

According to some embodiments, a second party (marked as “B side retailer”) may refer to any type of a commercial entity. According to some embodiments, a second server may be in communication with the second party. According to some embodiments, the second server may be integrated into the second party. As a non-liming example, the second server may include, among others, a self-checkout machine, and the like. According to some embodiments, the second server may include a UI 524 for enabling communication with a user. According to some embodiments, UI 524 may include, among others, one or more of: a touch screen, a mouse, a keyboard, a mobile application, and the like. According to some embodiments, a second processor of the second party may be configured to execute a code configured to receive PII from a user.

According to some embodiments and as depicted in FIG. 5, the second server, on behalf of the second party, may request the user to provide, among others, PII thereof, including a credit or debit card number, paypal information, name on the card, card number, and the like. According to some embodiments and as depicted in FIG. 5, the second party may request the user to provide his/her contact information, such as but not limited to, email address, phone number, ID/Passport number, and the like or any combination thereof. According to some embodiments, a second processor of the second server is configured to execute a code configured to receive the PII of the user. According to some embodiments, the second processor of the second server is configured to execute a code configured to generate a second anonymized (or fully anonymized) ciphertext from the PII provided by the user.

According to some embodiments, the second ciphertext may be generated based on, at least in part, on CHF methodologies, as elaborated elsewhere herein. Alternatively, in some embodiments, the second ciphertext may be generated based on, at least in part, on asymmetric encryption methodologies, as elaborated elsewhere herein.

According to some embodiments, the second processor of the second server is configured to execute a code configured to transmit the second anonymized (or fully anonymized) ciphertext from the second server to a buffer server 530. According to some embodiments, a third processor of buffer server 530 is configured to execute a code configured to search for a match between the second ciphertext and a first ciphertext (or a first party database comprising a plurality of first cyphertexts of each user of the first party) received from the first party. In some embodiments, the third process is configured to execute a code configured to execute a first set or rules, in case the match was found, thereby allowing the user to communicate with the first party and execute a transaction with the first party via the second party without sharing the actions of the user with the first party. Put differently, attempts of execution of the rules may not be known to the first party. As a non-limiting example, in a scenario in which a first party may include a credit card company and a second party may include a company offering services or selling goods and the like, wherein a user of the second party may receive an incentive/offer to pay for goods, services and the like, by using a specific credit card (e.g., offering an extra discount to the specific card owners, offering to make a purchase via credit card points, and the like), such that the execution attempts (e.g., exposing the user to the discount) may not be shared with the first party.

In some embodiments, the first party may not be exposed to the actions of the user and the execution attempts, while buffer server 530 may not be exposed to the PII of the user, thereby protecting the privacy of the users and the costumers. In some embodiments, buffer server 530 and the second server may not be exposed to the PII of the user.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods, according to some embodiments, may be described in a specific sequence, the methods of the disclosure may include some or all of the described stages carried out in a different order. In particular, it is to be understood that the order of stages and sub-stages of any of the described methods may be reordered unless the context clearly dictates otherwise, for example, when a latter stage requires as input an output of a former stage or when a latter stage requires a product of a former stage. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1. A cryptographic communication platform for performing a transaction/interaction between two or more parties, the platform comprising:
a first server comprising a first processor executing a code configured to:
receive, a personally identifiable information (PII) of a user of a first party;
generate a first anonymized ciphertext from the PII of the user of the first party;
transmit the first anonymized ciphertext server, such that transmitting the PII of the user of the first party is avoided;
a second server comprising a second processor executing a code configured to:
receive, a personally identifiable information (PII) of a user of a second party;
generate a second anonymized ciphertext from the PII of the user of the second party; and
transmit the second anonymized ciphertext to, such that transmitting the PII the user of the second party is avoided; and
a buffer server comprising a third processor executing a code configured to:
receive and store the first anonymized ciphertext from the first server and the second anonymized ciphertext from the second server;
search for a match between the first and the second anonymized ciphertexts, thereby allowing performing a transaction/interaction between the first and the second party without transmitting the PII of users therebetween.

2. The platform of claim 1, wherein the first anonymized cipher text is configured to be equal to the second anonymized cipher text to allow the transaction/interaction, and wherein the search for the match comprises searching for equality between the first ciphertext and the second ciphertext to allow performing the transaction/interaction.

3. The platform of claim 1, wherein the first and the second servers comprise common features.

4. The platform of claim 1, wherein each of the processors of the first server and the second server is configured to generate the first and the second anonymized ciphertext, respectively, by using a cryptographic hash function (CHF).

5. The platform of claim 1, further comprising a key management system (KMS), the KMS is configured to:
generate a first cryptographic key for each of the PII of users; and
transmit the first cryptographic key to the first and the second servers.

6. The platform of claim 5, wherein the KMS is external to the buffer server, the first server and the second server.

7. The platform of claim 1, wherein each of the processors of the first and the second servers is configured to execute a code configured to:
receive PII of a user and the first cryptographic key;
determine rules for weaving the first cryptographic key into the PII of the user;
weave the first cryptographic key into the PII of each user according to the rules for weaving, thereby generating a first string, the first string comprising characters of the PII of the user and characters of the first cryptographic key; and
output the first string;
wherein the first cryptographic key used in the first server is identical to the first cryptographic key used in the second server; and
wherein the string is configured to be fed into the CHF for generating each of the first anonymized ciphertext and the second anonymized ciphertext by each of the first and the second server, respectively.

8. The platform of claim 1, wherein the first and the second processors execute a code further configured to:
receive a new first cryptographic key generated by the KMS;
store a previously used first cryptographic key and the rules for weaving thereof in a key history stack of each of the first server and the second server; and
replace the previously used first cryptographic key with the new first cryptographic key, thereby enabling backwards compatibility.

9. The platform of claim 1, wherein the third processor of the buffer server is configured to execute a code configured to:
receive the first anonymized ciphertext from the first server or the second anonymized ciphertext from the second server;
transmit the first anonymized ciphertext or the second anonymized ciphertext to the KMS, wherein the KMS is configured to generate a second cryptographic key, the second cryptographic key is stored in the KMS without being transmitted therefrom, the KMS is configured to weave the second cryptographic key into the first anonymized ciphertext or the second anonymized ciphertext, thereby generating a second string, the second string comprising characters of the first or the second anonymized ciphertexts and characters of the second cryptographic key, the KMS is configured to feed the second string into the CHF, thereby generating an encrypted form of the first or the second anonymized ciphertext; and
receive and store the encrypted form of the first or the second anonymized ciphertext in a buffer database, thereby updating the database, enabling backward compatibility, and minimizing/preventing dictionary attacks.

10. The platform of claim 1, wherein the third processor of the buffer server or the second processor of the second server is configured to execute a first set of rules, the first set of rules is determined by the first and/or the second party, and wherein attempts to execute the first set of rules for the user of the second party are unknown to the first party.

11. The platform of claim 1, wherein the third processor of the buffer server or the second processor of the second server is configured to execute a second set of rules, the second set of rules is determined by the first and/or the second party in case the match is not found.

12. The platform of claim 1, wherein the processors of the first and second servers execute a code further configured to:
attach dynamic metadata to each of the first and the second anonymized ciphertext, thereby enabling user segmentation.

13. A cryptographic communication platform for performing a transaction/interaction between two or more parties, the platform comprising:
a first server comprising a first processor executing a code configured to:
receive a PII of a user of a first party;
generate, by applying an asymmetric encryption method, a first anonymized ciphertext from the PII of the user of the first party;
transmit the first anonymized ciphertext server, such that transmitting the PII of the user of the first party is avoided;
a second server comprising a second processor executing a code configured to:
receive, a PII of a user of a second party;
generate, by applying the asymmetric encryption method, a second anonymized ciphertext from the PII of the user of the second party; and
transmit the second anonymized ciphertext to, such that transmitting the PII the user of the second party is avoided; and
a buffer server comprising a third processor executing a code configured to:
receive and store the first anonymized ciphertext from the first server and the second anonymized ciphertext from the second server;
search for a match between the first and the second anonymized ciphertexts, thereby allowing performing a transaction/interaction between the first and the second party without transmitting the PII of users therebetween.

14. The platform of claim 13, further comprising an KMS, the KMS is configured to:
generate a first pair of asymmetric keys for encrypting the PII of users of the first party; and
generate a second pair of asymmetric keys for encrypting the PII of users of the second party.

15. The platform of claim 13, wherein the buffer server is configured to resolve a dispute between the first and the second party by restoring the transaction/interaction therebetween.

16. A computer implemented method for secured interaction between two or more parties, the method comprising:
receiving a PII of a user of a first party;
generating a first anonymized ciphertext from the PII of user of a first party by a first server;
transmitting the first ciphertext to a buffer server, such that transmitting the PII of users of the first party is avoided;
receiving a PII of a user of a second party;
generating a second anonymized ciphertext from a PII of user of a second party by a second server;
transmitting the second anonymized ciphertext to the buffer server, such that transmitting the PII of users of the second party is avoided;
receiving, by the buffer server, the first anonymized ciphertext from the first server and the second anonymized ciphertext from the second server;
searching for a match between the first and the second anonymized ciphertexts, thereby allowing performing a transaction/interaction between the first and the second party without transmitting the PII of users therebetween, and wherein performing the transaction/interaction comprises executing a set of rules defined by the first party and/or the second party without revealing attempts of the execution of the set of rules to the first or the second party.

17. The method of claim 16, wherein receiving a PII of a user comprises receiving a database of users of the first/second party.

18. The method of claim 16, wherein generating each of the first and the second anonymized ciphertext is performed by using a CHF.

19. The method of claim 16, wherein generating each of the first and the second anonymized ciphertext by each of the first and the second server, respectively, comprises:
generating a first cryptographic key;
determining rules for weaving the first cryptographic key into the PII of each user;
weaving the first cryptographic key into the PII of each user, thereby generating a first string, wherein the first cryptographic key used in the second server is identical to the first cryptographic key used in the first server;
feeding each of the first string into the CHF for generating each of the first anonymized ciphertext and the second anonymized ciphertext by each of the first and the second server, respectively.

20. The method of claim 19, wherein the first cryptographic key is generated by an KMS.

21.-26. (canceled)
